(19) United States
(12) Patent Application Publication
(10) Pub. No.: US 2024/0394492 A1
(43) Pub. Date: Nov. 28, 2024

(54) IMAGE FORMING APPARATUS

(71) Applicant: CANON KABUSHIKI KAISHA, Tokyo (JP)

(72) Inventor: EIKOU MORI, Tokyo (JP)

(21) Appl. No.: 18/669,027

(22) Filed: May 20, 2024

(30) Foreign Application Priority Data
May 25, 2023 (JP) 2023-086225

(51) Int. Cl. G06K 15/02; H04N 1/00; H04N 1/12

(52) U.S. Cl. CPC G06K 15/027; G06K 15/1868; H04N 1/00795; H04N 1/1215; G06K 2215/101; H04N 2201/0081

(57) ABSTRACT

An image forming apparatus includes an image forming unit configured to form an image on a sheet, a conveyance unit configured to convey the sheet from the image forming unit to a reading position, a sensor configured to output a signal synchronized with a conveyance speed of the conveyance unit, a reading unit configured to read the sheet while the sheet conveyed by the conveyance unit passes through the reading position, and an adjustment unit configured to adjust, based on a reading result of the sheet read by the reading unit and the signal output by the sensor, misregistration between an image to be formed on a first surface of the sheet by the image forming unit and an image to be formed on a second surface of the sheet by the image forming unit.

### BACKGROUND

### Field of the Disclosure

The present disclosure relates to an image forming apparatus, such as a printing machine, a copying machine, or a printer, that forms an image on a sheet.

### Description of the Related Art

A market for an image forming apparatus of an on-demand type is expanding. Such image forming apparatus employs an electrophotographic method, which is spreading also into an offset printing market, or an inkjet method, which has successfully developed a wide range of markets including large format, low initial cost, and ultra-high speed. For further expansion of a market, it is required to maintain quality of an image (hereinafter referred to as “image quality”) provided by an image forming apparatus that has been playing a leading role in the market. Examples of the image quality include granularity, in-plane uniformity, text quality, and color reproducibility (including color stability).

One important element of the image quality is “front-to-back registration accuracy.” The front-to-back registration accuracy refers to the accuracy of alignment between an image on a front surface and an image on a back surface at the time of duplex printing. Print-position misregistration between an image on a front surface and an image on a back surface of a product in duplex printing is referred to as “front-to-back misregistration.” An offset printing machine involves adjustment of the front-to-back misregistration by a skilled technician before printing. However, the adjustment of the front-to-back misregistration takes time and requires skilled expertise.

An image forming apparatus that handles cut sheets can provide stability in print positions with high accuracy through alignment (registration). The registration is usually performed with one side of a rectangular sheet as a reference. Thus, accuracy variation of print positions per sheet is influenced by the cutting accuracy for sheets and deformation of sheets. The shape of the sheet is determined by a length of each side, perpendicularity, and parallelism of each side. Those accuracies are significantly influenced by the cutting accuracy for sheets (lot difference) and the surrounding environment. The front-to-back registration accuracy is influenced by the shape of the sheet. Thus, in order to maintain the front-to-back print accuracy equivalent to that of offset printing in the image forming apparatus that handles cut sheets, the work of adjusting the front-to-back misregistration through adjustment of, for example, print positions, magnifications, and distortions, that is, the front-to-back registration is required every time the cutting lot for sheets or the surrounding environment changes.

Japanese Patent Application Laid-open No. 2018-004954 discloses an image forming apparatus that calculates adjustment amounts for print-position adjustment based on results of reading a sheet having test images printed thereon a plurality of times with use of a reading sensor provided to the image forming apparatus. Japanese Patent Application Laid-open No. 2005-221582 discloses an image forming apparatus that automatically adjusts a print position during a print job. In order to obtain adjustment values for the print position with high accuracy, it is required to improve the reading accuracy at the time of reading a sheet having test images printed thereon. At the time of measuring a length of a sheet for improvement in the reading accuracy, a conveyance speed for the sheet before forming an image on the sheet and a conveyance speed for the sheet at the time of forming an image on the sheet are measured, and the measurement results are fed back to the length of the sheet obtained from the reading result of the sheet. U.S. Pat. No. 8,639,174 discloses an image forming apparatus that performs image-magnification adjustment based on the length of the sheet measured in such a manner.

In order to adjust a print position with high accuracy, it is essentially required to improve the reading accuracy for a sheet by the reading sensor. Especially in a case where the reading sensor reads a sheet being conveyed, the reading sensor may not read the sheet (and test images on the sheet) with high accuracy due to errors in an actual conveyance speed for the sheet compared to a target conveyance speed (nominal speed) for the sheet (speed variation). In this case, appropriate calibration may not be performed.

### SUMMARY

According to embodiments of the present disclosure, an image forming apparatus includes an image forming unit configured to form an image on a sheet, a conveyance unit configured to convey the sheet from the image forming unit to a reading position, a sensor configured to output a signal synchronized with a conveyance speed of the conveyance unit, a reading unit configured to read the sheet while the sheet conveyed by the conveyance unit passes through the reading position, and an adjustment unit configured to adjust, based on a reading result of the sheet read by the reading unit and the signal output by the sensor, misregistration between an image to be formed on a first surface of the sheet by the image forming unit and an image to be formed on a second surface of the sheet by the image forming unit, the second surface being a back surface with respect to the first surface.

Further features of the present disclosure will become apparent from the following description of exemplary embodiments (with reference to the attached drawings).

### BRIEF DESCRIPTION OF THE DRAWINGS

FIG. 1 is a configuration view of an image forming system.

FIG. 2 is a configuration explanatory view of an image forming portion of a print module.

FIG. 3 is a configuration view of a print belt unit.

FIG. 4 is a configuration view of a reading sensor (in-line scanner).

FIG. 5 is a configuration diagram of a control system.

FIG. 6 is an explanatory view for illustrating correction of a shape of a sheet and print positions of test images.

FIG. 7 is an explanatory view for illustrating front-to-back misregistration.

FIG. 8 is an explanatory view for illustrating print-position adjustment.

FIG. 9 is an explanatory view for illustrating image-magnification adjustment.

FIG. 10 is an explanatory view for illustrating reading-start-trigger correction.

### DESCRIPTION OF THE EMBODIMENTS

Now, referring to the accompanying drawings, description is given of at least one exemplary embodiment of the present disclosure.

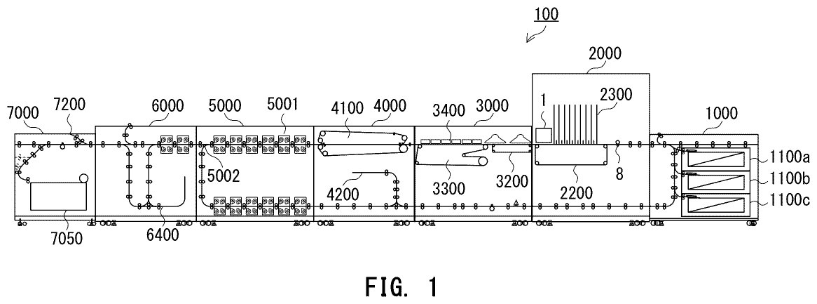

FIG. 1 is a configuration view of an image forming system in the at least one embodiment. An image forming system 100 is, for example, a printing machine to be used in a commercial and industrial printing field. The image forming system 100 in the at least one embodiment is a sheet-fed inkjet recording apparatus which generates a printed product by forming an ink image on a sheet with use of two liquids which are a reaction liquid and ink. The image forming system 100 includes a sheet feeding module 1000, a print module 2000, a drying module 3000, a fixing module 4000, a cooling module 5000, a reversing module 6000, and a delivery stacking module 7000. A sheet being a cut sheet on which an image is to be printed is fed from the sheet feeding module 1000, receives predetermined processing at each module, and is delivered to the delivery stacking module 7000.

The sheet feeding module 1000 includes a plurality of (in the at least one embodiment, three tiers of) sheet storage portions 1100a to 1100c. The sheet storage portions 1100a to 1100c can each store sheets. The sheet storage portions 1100a to 1100c are configured so that each sheet storage portion can be pulled out to a front side of the apparatus. Hence, the sheet storage portions 1100a to 1100c are pulled out to the front side of the apparatus to receive sheets. The sheet feeding module 1000 feeds sheets one by one to the print module 2000. Accordingly, the sheet storage portions 1100a to 1100c each include a separation belt and a conveying roller. The number of the sheet storage portions 1100a to 1100c is an example, and a single tier of sheet storage portion, or two, or four or more, tiers of sheet storage portions may be provided.

The print module 2000 is an inkjet image forming apparatus, and forms an image on the sheet fed from the sheet feeding module 1000. The print module 2000 includes a pre-image-forming registration correction portion 8, a print belt unit 2200, and a recording portion 2300. A tilt and a position of the sheet fed from the sheet feeding module 1000 are corrected by the pre-image-forming registration correction portion 8, and then, the corrected sheet is conveyed to the print belt unit 2200.

The print belt unit 2200 and the recording portion 2300 are arranged so as to face each other across a conveying path of the sheet, on a downstream side of the pre-image-forming registration correction portion 8 in a conveying direction of the sheet. The print belt unit 2200 attracts and conveys the sheet conveyed from the pre-image-forming registration correction portion 8. The recording portion 2300 is a sheet processing portion for forming an image on the sheet conveyed by the print belt unit 2200 by performing, from above the sheet, recording processing (printing) with a recording head. A clearance between the recording head and the sheet is kept constant due to attraction and conveyance of the sheet by the print belt unit 2200.

A plurality of recording heads are arranged side by side along the conveying direction of the sheet. The recording head in the at least one embodiment includes eight line-type recording heads corresponding to four colors of yellow (Y), magenta (M), cyan (C), and black (K) as well as a reaction liquid and three spot colors. The number of colors and the number of recording heads are not limited thereto. Examples of an adoptable inkjet method include a method that uses a heating element, a method that uses a piezo element, a method that uses an electrostatic element, and a method that uses a MEMS element. Ink of each color is supplied to the corresponding recording head via an ink tube from an ink tank (not shown).

A sheet S on which printing has been executed by the recording portion 2300 is conveyed by the print belt unit 2200. An in-line scanner 1 serving as a reading sensor is placed on a downstream side of the recording portion 2300 in the conveying direction. The in-line scanner 1 is used to correct a printed image by detecting misalignment and color concentrations of the image formed on the sheet, details of which are to be described later.

The drying module 3000 dries the sheet on which the image has been formed by the print module 2000. The drying module 3000 reduces a liquid constituent contained in the ink by drying the sheet, to thereby improve fixability of the ink to the sheet. The drying module 3000 includes a decoupling portion 3200, a drying belt unit 3300, and a hot air blowing portion 3400.

The sheet S on which printing has been executed by the recording portion 2300 of the print module 2000 is conveyed to the decoupling portion 3200 inside the drying module 3000. The decoupling portion 3200 conveys the sheet by lightly holding the sheet with use of a wind pressure from above and friction from a belt. This prevents misalignment of a part of the sheet that remains on the print belt unit 2200 in a case where the sheet lays partially on the decoupling portion 3200 and the rest of the sheet is on the print belt unit 2200.

The sheet conveyed from the decoupling portion 3200 is attracted and conveyed by the drying belt unit 3300, and hot air is concurrently blown onto the sheet from the hot air blowing portion 3400 placed above the belt, to thereby dry an ink applied surface (image printed surface). The drying method may have a configuration obtained by combining the method of blowing hot air with a method of irradiating a sheet surface with an electromagnetic wave (an ultraviolet ray, an infrared ray, or the like), or a conductive heat transfer method by contact with a heat generator.

The fixing module 4000 fixes the image to the sheet by heating the sheet that has been dried by the drying module 3000, and thus drying the ink. The fixing module 4000 includes a fixing belt unit 4100 which includes an upper belt unit and a lower belt unit. The fixing module 4000 passes the sheet that has been conveyed from the drying module 3000 between the upper belt unit and the lower belt unit which have been heated, to thereby fix the ink to the sheet.

The cooling module 5000 cools the sheet to which the image has been fixed by the fixing module 4000, to thereby solidify the ink softened from heating, and, at the same time, suppress a temperature change caused in the sheet by a downstream apparatus. The cooling module 5000 includes a plurality of cooling portions 5001. The plurality of cooling portions 5001 cool the high-temperature sheet conveyed from the fixing module 4000. The cooling portions 5001 are each configured so as to raise a pressure in a cooling box by taking outside air into the cooling box with use of a fan, apply a wind blown out of a nozzle formed in a conveying guide onto the sheet, and thus cool the sheet. The plurality of cooling portions 5001 are arranged on each side of the conveying path so that the sheet can be cooled from both sides.

A conveying path switching portion 5002 is provided in the cooling module 5000. The conveying path switching portion 5002 switches the conveying path of the sheet depending on whether the sheet is to be conveyed to the reversing module 6000 or to a duplex-printing conveying path to be used in duplex printing.

In duplex printing, the sheet is conveyed to the conveying path in a lower part of the cooling module 5000, and then is conveyed through the duplex-printing conveying path of the fixing module 4000, the drying module 3000, the print module 2000, and the sheet feeding module 1000. A duplex-printing portion of the fixing module 4000 is provided with a first reversing portion 4200 for reversing a front surface and a back surface of the sheet. The sheet is conveyed to the first reversing portion 4200 once, and then reversed and conveyed to the drying module 3000 side, and the image printing surface is thus reversed. The stop at the first reversing portion 4200 enables printing on the back surface of the sheet. After that, the sheet is again conveyed to the pre-image-forming registration correction portion 8, the print belt unit 2200, and the recording portion 2300 of the print module 2000 to be printed on.

The reversing module 6000 includes a second reversing portion 6400. The reversing module 6000 uses the second reversing portion 6400 to reverse the front surface and the back surface of the sheet being conveyed. Directions in which the front surface and the back surface of the sheet that is about to be delivered can thus be changed. The delivery stacking module 7000 includes a top tray 7200 and a stacking portion 7500. The delivery stacking module 7000 stacks, in an orderly manner, sheets conveyed from the reversing module 6000.

### <Print Module>

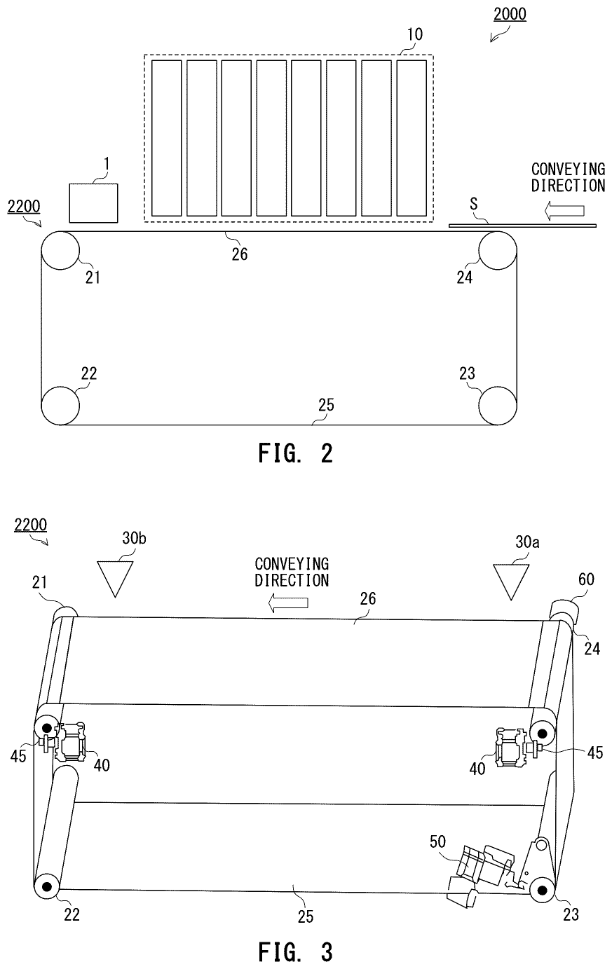

FIG. 2 is a configuration explanatory view of an image forming portion of the print module 2000. The print module 2000 includes a recording head 10 which serves as an image forming portion as described above, the print belt unit 2200 that conveys the sheet S, and the in-line scanner 1. The recording head 10 forms an image on the sheet S by jetting ink from above with respect to the sheet S that has been fed one by one from the sheet feeding module 1000 and has passed through the pre-image-forming registration correcting portion 8.

In such case, the sheet S is attracted through suction by the print belt unit 2200 and conveyed in the conveying direction. The attraction through suction by the print belt unit 2200 stabilizes the conveyance behavior of the sheet S so that a distance with respect to the recording head 10 at the time of image formation is kept constant. The print belt unit 2200 includes a plurality of (four in the at least one embodiment) stretch rollers 21 to 24 and a print belt 25 stretched by the stretch rollers 21 to 24. The sheet S is attracted through suction onto a belt surface of the print belt 25 stretched by the stretch roller 21 and the stretch roller 24. The image formation is performed on the belt surface. Thus, in the at least one embodiment, the belt surface extending between the stretch roller 21 and the stretch roller 24 is referred to as an image formation surface 26.

The print belt 25 has a large number of suction holes for suction with respect to the sheet S, and rotates counterclockwise in FIG. 2. In a space surrounded by the print belt 25, a vacuum (not shown) is provided for suction. The print belt 25 attracts the sheet S onto the image formation surface 26 with a suction force generated by the vacuum and rotates to convey the sucked sheet S in the conveying direction. The sheet S attracted onto the image formation surface 26 is conveyed under a state in which a certain clearance is secured between the sheet S and the recording head 10. The print belt 25 functions as a conveyance portion that carries and conveys the sheet S. The recording head 10 includes a plurality of heads arranged side by side along the conveying direction for the sheet S. As described above, the recording head 10 in the at least one embodiment has eight line-type recording heads corresponding to four colors of black, yellow, magenta, and cyan as well as a reaction liquid and three spot colors.

The in-line scanner 1 is arranged on a downstream side of the recording head 10 in the conveying direction for the sheet S and reads test images printed on the sheet S being conveyed by the print belt unit 2200. The test images are used for detecting geometric characteristics (for example, a print position and a shape) of an image formed on the sheet. The test images described in the at least one embodiment are each a mark having a shape of two crossing straight line segments and are also referred to as register marks. Based on the reading result (read image) of the sheet S by the in-line scanner 1, geometric characteristics, such as a print position and a shape, of the image are detected. Based on a difference between the geometric characteristics obtained from the read image and nominal geometric characteristics, correction values for the geometric characteristics are generated. A print position of the image given at the time of image formation is adjusted with the correction values.

### <Print Belt Unit>

FIG. 3 is a configuration view of the print belt unit 2200. Here, control for the print belt unit 2200 in a belt width direction is described. The belt width direction is a direction orthogonal to the conveying direction for the sheet S.

In the print belt unit 2200 of the at least one embodiment, the stretch roller 21 is a drive roller that rotates the print belt 25. The stretch roller 21 is movable in a roller shaft direction (belt width direction). The stretch roller 22 is a tension roller for applying tension to the print belt 25. The stretch roller 23 is a steering roller that can incline by moving one roller shaft end portion in order to suppress meandering of the belt. The stretch roller 23 is driven by a drive source 50 so that the roller shaft end portion of the stretch roller 23 moves. The stretch roller 24 is a driven roller that is driven by the rotation of the print belt 25 and movable in the roller shaft direction (belt width direction).

In the vicinity of the stretch roller 21 and the stretch roller 24 that are movable in the belt width direction, sensors 30a and 30b for detecting positions of an edge of the print belt 25 are arranged. The accuracy of the print position on the sheet S can be improved by accurately positioning the attraction position for the sheet S on the image formation surface 26.

Rollers that are movable in the belt width direction for adjustment of the image formation surface 26 are the two stretch rollers 21 and 24 forming the image formation surface 26. Further, the sensors 30a and 30b that detect the positions of the print belt 25 are provided in the vicinity of the stretch rollers 21 and 24. The stretch roller 21 moves in the belt width direction based on a belt position detection result given by the sensor 30b to adjust a belt position. The stretch roller 24 moves in the belt width direction based on a belt position detection result given by the sensor 30a to adjust a belt position. Each of the stretch rollers 21 and 24 forming the image formation surface 26 adjusts the belt position, thereby being capable of positioning the print position accurately on the entire image formation surface 26.

An encoder 60 is provided on the roller shaft of the stretch roller 24. The encoder 60 is caused to output an encoder waveform by the rotation of the stretch roller 24. The encoder waveform is an output signal (pulse wave) having a cycle corresponding to the rotation speed of the stretch roller 24. A length of the cycle of the pulse wave changes in accordance with the rotation speed of the stretch roller 24. The stretch roller 24 is rotationally driven by the print belt 25, and hence the output signal of the encoder 60 (encoder waveform) provides data synchronized with the rotation speed of the print belt 25 (speed in the conveying direction). Further, the output signal of the encoder 60 (encoder waveform) may also be regarded as data synchronized with the conveyance speed for the sheet S. The output signal of the encoder 60 (encoder waveform) may be used to always monitor the speed of the print belt 25 in the conveying direction, that is, the conveyance speed for the sheet S. That is, the encoder 60 is a speed detector that detects the conveyance speed for the sheet S.

### <In-Line Scanner>

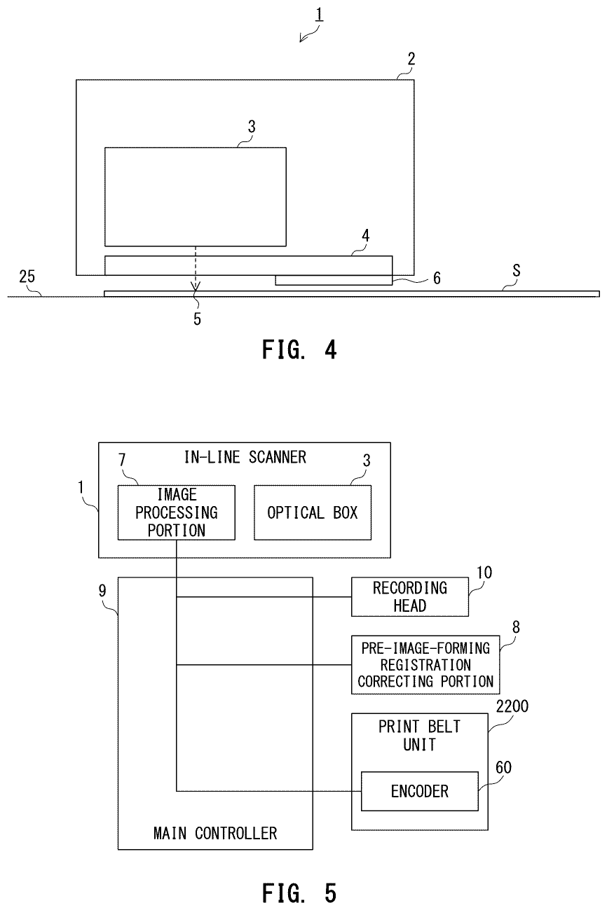

FIG. 4 is a configuration view of the in-line scanner 1. The in-line scanner 1 reads the sheet S on the print belt 25 and test images printed on the sheet S.

The in-line scanner 1 has an optical box 3 inside a housing 2. The housing 2 is provided with a reading glass 4 and a shading sheet 6 on the print belt 25 side. The optical box 3 accommodates a light source (not shown) and a line sensor (not shown). The light source irradiates a reading position 5 with light via the reading glass 4. The line sensor receives light reflected from a read object located at the reading position 5. The in-line scanner 1 is an optical sensor that performs reading processing of reading the read object with use of the light source and the line sensor. A shape of the sheet S and print positions of the test images are detected based on a read image obtained by the reading processing.

The in-line scanner 1 is capable of moving the optical box 3 in a right-and-left direction in FIG. 4 with a driving portion (not shown). In a case of performing shading correction processing, the in-line scanner 1 moves the optical box 3 from the position for reading the sheet S to a position for reading the shading sheet 6 to perform the reading processing. The shading correction for the reading result (read image) obtained by the line sensor of the optical box 3 is performed based on the reading result obtained by reading the shading sheet 6.

### <Control System>

FIG. 5 is a configuration diagram of a control system that controls operation of the print module 2000. This control system includes a main controller 9 and is built in the print module 2000. The main controller 9 is formed of a semiconductor device or a combination of electronic components. Examples of the semiconductor device to be used include a central processing unit (CPU), a microprocessing unit (MPU), and an application-specific integrated circuit (ASIC). Examples of the semiconductor device to be used may also include a system-on-a-chip (SoC).

The main controller 9 controls overall operation of the print module 2000. The main controller 9 has the in-line scanner 1, the recording head 10, the pre-image-forming registration correcting portion 8, and the print belt unit 2200 connected thereto. The in-line scanner 1 further includes an image processing portion 7 for performing predetermined image processing on the reading result (read image) obtained by the line sensor of the optical box 3. The print belt unit 2200 has the encoder 60 described above.

The image processing portion 7 of the in-line scanner 1 performs the image processing on the reading result (read image) obtained by the line sensor of the optical box 3 to generate data of a shape of the sheet S and print positions (coordinates) of the test images. The image processing portion 7 acquires, via the main controller 9, an output signal (encoder waveform) of the encoder 60 given when the in-line scanner 1 reads the sheet S. In order to suppress reading errors caused by the speed variation in the conveying direction of the print belt 25, the image processing portion 7 corrects the data of the shape of the sheet S and the print positions (coordinates) of the test images based on the acquired output signal (encoder waveform). From the data of the shape of the sheet S and the print positions (coordinates) of the test images which has thus been obtained, correction values for the print positions and the sheet position are generated. The correction values are transmitted to the main controller 9.

The main controller 9 reflects the correction values that have been acquired from the in-line scanner 1 to the processing in the pre-image-forming registration correcting portion 8, the print belt unit 2200, and the recording portion 2300. In this manner, adjustment of, for example, a position of an image with respect to the sheet S, a position of the sheet S that passes through the recording head 10, and an image magnification in the conveying direction for the sheet S is performed. That is, the main controller 9 corrects image forming conditions given at the time of image formation based on the correction values to adjust the print position of the image formed on the sheet S.

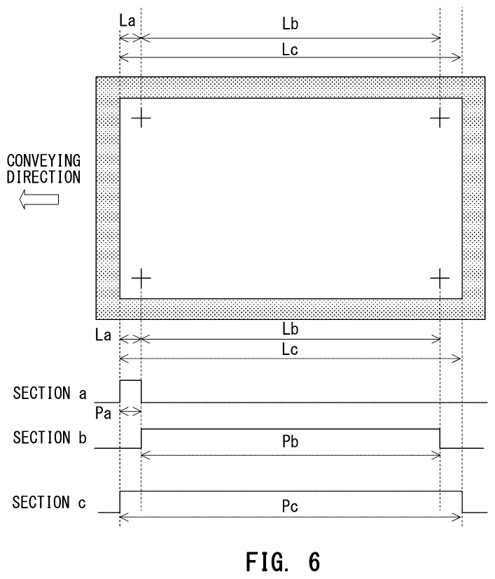

FIG. 6 is an explanatory view for illustrating correction of the shape of the sheet S and the print positions of the test images (read signals). FIG. 6 shows a reading result (read image) obtained by the in-line scanner 1 reading the sheet S.

The image processing portion 7 determines, from the read image, positions of a leading edge side, a trailing edge side, a left edge side, and a right edge side of the sheet as well as positions of the test images. Specifically, the image processing portion 7 depicts the read image on an imaginary plane (two-dimensional) and acquires the positions of the leading edge side, the trailing edge side, the left edge side, and the right edge side as well as the positions of the test images as pieces of information of coordinates on the imaginary plane. Based on the position (coordinates) of the leading edge side, the position (coordinates) of the trailing edge side, and the positions (coordinates) of the test images that have been determined from the read image, the image processing portion 7 acquires a margin La from the sheet leading edge side to the test image, an image length Lb, and a sheet length Lc. Herein, the sheet leading edge side is a downstream side in the conveying direction, and the sheet trailing edge side is an upstream side in the conveying direction. The image length Lb is a distance in the conveying direction between the test image formed in a leading-edge region of the sheet and the test image formed in a trailing-edge region of the sheet. The sheet length Lc is a length in the conveying direction from the sheet leading edge side to the sheet trailing edge side in the conveying direction.

The image processing portion 7 counts pulse numbers Pa, Pb, and Pc of encoder waveforms output from the encoder 60 in a section “a”, a section “b”, and a section “c” corresponding to the margin La, the image length Lb, and the sheet length Lc. The amount by which the print belt 25 advances in one pulse of the encoder waveform is fixed. Thus, when the conveyance speed by the print belt 25 is at a target conveyance speed, the time corresponding to the distance from the leading edge side or the trailing edge side of the sheet P to each of the test images (or the distance from the test images on the leading edge side to the test images on the trailing edge side) is fixed. The image processing portion 7 performs the image processing so as to correct magnifications of the sections of the read image based on the pulse numbers in the times corresponding to the respective sections.

The image processing portion 7 calculates section correction values Pa/Pa′, Pb/Pb′, and Pc/Pc′ as correction values for correcting the read image. The nominal pulse numbers Pa′, Pb′, and Pc′ are pulse numbers of the encoder waveform given when the test images are printed at ideal positions and the sheet P is conveyed at an ideal conveyance speed. The section correction values Pa/Pa′, Pb/Pb′, and Pc/Pc′ are correction values to be used for correcting the speed variation of the print belt 25 in the respective sections.

The image processing portion 7 multiplies the margin La, the image length Lb, and the sheet length Lc by the section correction values Pa/Pa′, Pb/Pb′, and Pc/Pc′, respectively, to correct the shape of the sheet and the print positions of the test images. Specifically, the image processing portion 7 corrects the coordinates of the leading edge side, the trailing edge side, the left edge side, and the right edge side as well as the coordinates of the test images based on the section correction values Pa/Pa′, Pb/Pb′, and Pc/Pc′. Then, the shape of the sheet S and the print positions of the test images are determined based on the corrected coordinates. In the manner described above, the shape of the sheet S and the print positions of the test images are corrected in accordance with the speed fluctuation of the print belt unit 2200.

At the time of acquiring the margin La, the image length Lb, and the sheet length Lc from the read image by the image processing portion 7, the margin La, the image length Lb, and the sheet length Lc are measured at both edges in the belt width direction and averaged. In this manner, even in a case where the sheet S advances with skew, the shape of the sheet S and the print positions of the test images can be accurately digitized.

In a case where the values expressing the shape of the sheet S and the print positions of the test images are corrected with the encoder waveform expressing the speed measurement result for the print belt 25 (conveyance speed for the sheet S) in the manner as described above, the reading accuracy of the in-line scanner 1 is improved. In the following, description is given of examples of performing front-to-back registration adjustment of correcting front-to-back misregistration, print-position adjustment, and image-magnification adjustment based on the shape of the sheet S and the print positions of the test images. Further, description is given of an example of correcting reading-start-timing of the in-line scanner 1 based on the speed measurement result for the print belt 25.

### (1) Front-to-Back Registration Adjustment

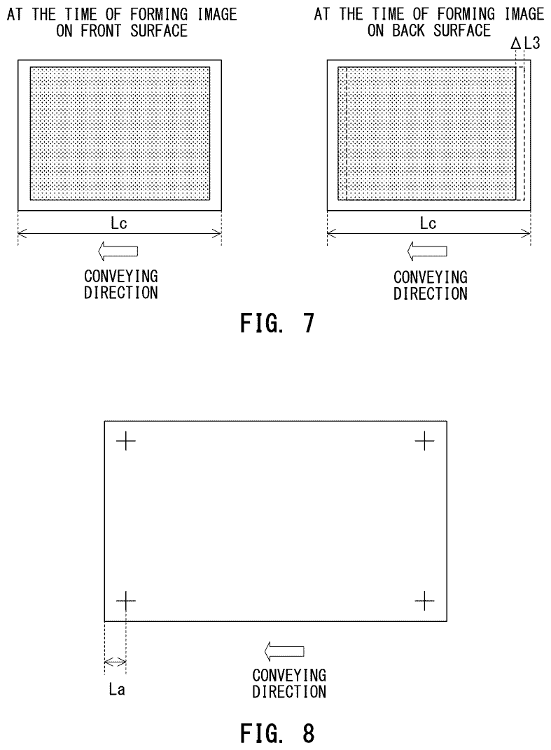

FIG. 7 is an explanatory view for illustrating the front-to-back misregistration. The front-to-back misregistration occurs in a case where the length of the sheet S in the conveying direction (sheet length) is different from a nominal dimension.

Case in which the Sheet Length is the Same as the Nominal Dimension:

In a case where the printing on the sheet S by the recording portion 2300 is performed at the timing based on the nominal dimension, respective image leading edges on the front surface and the back surface are located at distances corresponding to the nominal dimension from the sheet leading edge. In a case where the printing is performed on both of the front surface and the back surface of the sheet S, an image leading edge on the front surface and an image trailing edge on the back surface match each other.

Case in which the Sheet Length is Different from the Nominal Dimension:

Even in a case where the sheet length Lc is different from a nominal length Lc′, respective image leading edges on the front surface and the back surface are located at a distance corresponding to the nominal dimension from the sheet leading edge. Thus, a difference in sheet length as expressed by ΔLc=Lc−Lc′ causes a deviation ΔLc of the image trailing edge on the back surface with respect to the image leading edge on the front surface. The image processing portion 7 measures the sheet length Lc of the sheet S given after printing on the front surface from the read image given by the in-line scanner 1 to calculate the sheet length difference and the deviation ΔLc in advance. At the time of printing on the back surface, the main controller 9 gives an offset to the print timing of the recording portion 2300 or the sheet position in accordance with the deviation ΔLc, thereby being capable of correcting the deviation of the image trailing edge on the back surface with respect to the image leading edge on the front surface.

The reading accuracy of the in-line scanner 1 is improved by performing correction of the shape of the sheet S and the print positions of the test images based on the measurement result for the speed of the print belt 25. Thus, it is not required to perform averaging processing with respect to the measurement result of the sheet length. As a result, the front-to-back registration adjustment with high accuracy can be achieved by measuring the sheet length Lc on the front surface and then feeding back the measurement result to the print timing on the back surface or the sheet position. Thus, the front-to-back registration adjustment can be performed without control delay, thereby being capable of achieving improvement in front-to-back registration accuracy corresponding to the sheet length fluctuation per sheet S.

### (2) Print-Position Adjustment

FIG. 8 is an explanatory view for illustrating the print-position adjustment. In a case where the printing on the sheet S by the recording portion 2300 is performed at the timing different from the timing based on the nominal dimension, the print-position misregistration occurs in the image printed on the sheet S.

In a case where the margin La from the sheet leading edge to the image leading edge is different from the margin amount La′ given in the case of the nominal dimension, the print timing of the recording portion 2300 on the sheet S deviates. Thus, the image processing portion 7 measures the margin La from the sheet leading edge to the image leading edge from the read image that has been read by the in-line scanner 1 from the sheet S having been subjected to printing. The image processing portion 7 calculates the deviation amount ΔLa=La−La′ given at the print timing of the recording portion 2300 on the sheet S based on the margin La that has been measured. The main controller 9 feeds back the deviation amount ΔLa to the print timing or the sheet position for control, thereby being capable of adjusting the print position of the image with respect to the sheet S to an appropriate print position.

The reading accuracy of the in-line scanner 1 is improved by performing the correction of the shape of the sheet S and the print positions of the test images based on the measurement result for the speed of the print belt 25. Thus, the adjustment accuracy for the print position is improved. Further, the front-to-back registration adjustment may also be performed with high accuracy by performing the above-mentioned adjustment of the print position with respect to both surfaces of the sheet.

### (3) Image-Magnification Adjustment

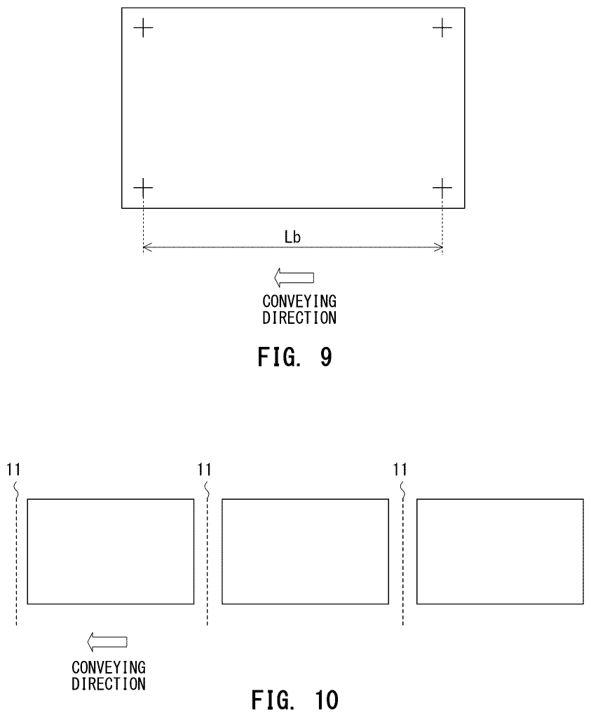

FIG. 9 is an explanatory view for illustrating the image-magnification adjustment. In a case where the conveyance speed for the sheet S at the time of printing by the recording portion 2300 is different from the nominal speed, the image magnification deviation occurs in the image printed on the sheet S.

In a case where the image length Lb is different from the nominal image length Lb′, the conveyance speed for the sheet S and an ejection frequency for ink given at the time of printing do not match. Thus, the image processing portion 7 measures the image length Lb from the read image obtained by the in-line scanner 1 reading the sheet S having been subjected to printing. The image processing portion 7 calculates the image length deviation ΔLb=Lb−Lb′ based on the image length Lb that has been measured. The image processing portion 7 calculates the image-magnification adjustment value=ΔLb/Lb′ from the image length deviation ΔLb. The main controller 9 is capable of appropriately adjusting the image magnification based on the calculated image-magnification adjustment value and the original image magnification.

The reading accuracy of the in-line scanner 1 is improved by performing the correction of the shape of the sheet S and the print positions of the test images based on the measurement result for the speed of the print belt 25. Thus, the adjustment accuracy for the image magnification is improved.

As described above, the reading accuracy of the in-line scanner 1 is improved by performing correction of the shape of the sheet S and the print positions of the test images based on the measurement result for the speed of the print belt 25 before performing the front-to-back registration adjustment, the print-position adjustment, or the image-magnification adjustment. Thus, the front-to-back registration adjustment, the print-position adjustment, or the image-magnification adjustment can be performed with high accuracy.

### <Reading-Start-Trigger Correction>

FIG. 10 is an explanatory view for illustrating the reading-start-trigger correction. The main controller 9 transmits, at the time of digitizing the shape of the sheet S and the print positions of the test images, a reading-start trigger indicating the timing at which the in-line scanner 1 starts the reading processing to the in-line scanner 1.

At the time of digitizing the edge of the sheet S, the in-line scanner 1 is required to acquire the read image with the reading-start trigger 11 as a reference and crop a region from the sheet leading edge to the sheet trailing edge from the read image that has been acquired. The main controller 9 is required to transmit the reading-start trigger 11 before reading of the sheet leading edge. In a case where the reading-start trigger 11 is transmitted with enough time with respect to the sheet leading edge in consideration of variation in the conveyance speed for the sheet S, the reading-start trigger 11 may be transmitted before the trailing edge of the preceding sheet passes through the reading position 5 of the in-line scanner 1. For example, in a case where the variation in the conveyance speed for the sheet S is large, the reading-start trigger 11 is transmitted before the trailing edge of the preceding sheet passes through the reading position 5 of the in-line scanner 1. In this case, the processing overlaps the digitizing processing for the trailing edge of the preceding sheet, with the result that the digitization of the sheet shape cannot be accurately performed.

Thus, the main controller 9 transmits the reading-start trigger 11 at the timing based on the measurement result for the speed of the print belt 25. In this manner, the main controller 9 can transmit the reading-start trigger 11 in accordance with the variation in the conveyance speed for the sheet S. Through the correction of the shape of the sheet S and the print positions of the test images performed in advance, even in a case where the interval of sheets is short, the trailing edge of the preceding sheet and the leading edge of the subsequent sheet can be read with distinction.

In the above, description has been given of the case in which the print module 2000 is an inkjet image forming apparatus. However, similar processing can be performed even with an electrophotographic image forming apparatus. In this case, the in-line scanner 1 reads the sheet S having an image fixed thereon. Correction values of geometric characteristics obtained based on the reading result (read image) obtained by the in-line scanner 1 are fed back to the image forming conditions.

As described above, the image forming system 100 of the at least one embodiment is improved in the reading accuracy by the in-line scanner 1 by correcting the reading error of the in-line scanner 1 caused by the error in the conveyance speed for the sheet S. In this manner, the geometric characteristics of an image, for example, the front-to-back registration accuracy is improved, thereby being capable of adjusting a position of an image with high accuracy. As the reading accuracy is improved, it is not required to make an attempt to improve the reading accuracy, for example, by averaging a plurality of reading results. Thus, delay in the feedback of the reading results to the image forming conditions does not occur.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-086225, filed May 25, 2023, which is hereby incorporated by reference herein in its entirety.

What is claimed is:

1. An image forming apparatus, comprising:
an image forming unit configured to form an image on a sheet;
a conveyance unit configured to convey the sheet from the image forming unit to a reading position;
a sensor configured to output a signal synchronized with a conveyance speed of the conveyance unit;
a reading unit configured to read the sheet while the sheet conveyed by the conveyance unit passes through the reading position; and
an adjustment unit configured to adjust, based on a reading result of the sheet read by the reading unit and the signal output by the sensor, misregistration between an image to be formed on a first surface of the sheet by the image forming unit and an image to be formed on a second surface of the sheet by the image forming unit, the second surface being a back surface with respect to the first surface.

2. The image forming apparatus according to claim 1, wherein the misregistration includes misregistration, in a conveying direction in which the sheet is conveyed by the conveyance unit, between a position of the image to be formed on the first surface and a position of the image to be formed on the second surface.

3. The image forming apparatus according to claim 1, wherein the misregistration includes a deviation, in a conveying direction in which the sheet is conveyed by the conveyance unit, between a magnification of the image to be formed on the first surface and a magnification of the image to be formed on the second surface.

4. The image forming apparatus according to claim 1, wherein the misregistration includes a deviation, in a conveying direction in which the sheet is conveyed by the conveyance unit, between a length of the image to be formed on the first surface and a length of the image to be formed on the second surface.

5. The image forming apparatus according to claim 1, wherein the adjustment unit is configured to adjust a position of the image to be formed on the second surface in a conveying direction in which the sheet is conveyed by the conveyance unit based on the reading result of the sheet read by the reading unit and the signal output by the sensor.

6. The image forming apparatus according to claim 5, wherein the adjustment unit is configured to adjust a position of the image to be formed on the first surface in the conveying direction in which the sheet is conveyed by the conveyance unit based on the reading result of the sheet read by the reading unit and the signal output by the sensor.

7. The image forming apparatus according to claim 1, wherein the adjustment unit is configured to adjust a magnification of the image to be formed on the second surface in a conveying direction in which the sheet is conveyed by the conveyance unit based on the reading result of the sheet read by the reading unit and the signal output by the sensor.

8. The image forming apparatus according to claim 1, wherein the adjustment unit is configured to adjust a length of the image to be formed on the second surface in a conveying direction in which the sheet is conveyed by the conveyance unit based on the reading result of the sheet read by the reading unit and the signal output by the sensor.

9. The image forming apparatus according to claim 1,
wherein the reading unit is configured to read a sheet having test images formed thereon by the image forming unit, the test images being formed in corner regions of the sheet, and
wherein the adjustment unit is configured to adjust the misregistration based on a reading result of the sheet having the test images formed thereon, which has been read by the reading unit, and the signal output by the sensor.

10. The image forming apparatus according to claim 9,
wherein the signal output by the sensor is a pulse signal,
wherein the test images include, in a conveying direction in which the sheet is conveyed by the conveyance unit, a first test image formed in a leading edge region of the sheet and a second test image formed in a trailing edge region of the sheet, and
wherein the adjustment unit is configured to:
acquire, based on the reading result of the sheet read by the reading unit, a length of a margin of the sheet from a leading edge side to the first test image in the conveying direction, a length from the first test image to the second test image in the conveying direction, and a length of the sheet; and
count pulse numbers of the pulse signal in sections corresponding to the length of the margin, the length from the first test image to the second test image, and the length of the sheet, and adjust the misregistration based on the pulse numbers that have been counted.

11. The image forming apparatus according to claim 1,
wherein the conveyance unit includes:
a belt configured to carry the sheet;
a drive roller configured to rotationally drive the belt; and
a driven roller configured to be driven by rotation of the belt, and
wherein the sensor is provided to the driven roller.

12. The image forming apparatus according to claim 1,
wherein the adjustment unit is configured to acquire information related to positions of a leading edge side, a trailing edge side, a left edge side, and a right edge side of the sheet based on the reading result of the sheet read by the reading unit, and
wherein the adjustment unit is configured to adjust the misregistration based on the information.
